(19) United States
(12) Patent Application Publication
(10) Pub. No.: US 2007/0036958 A1
(43) Pub. Date: Feb. 15, 2007

(54) Composite material with grain filler and method of making same

(75) Inventors: Ronald T. Hagemann, Loves Park, IL (US); Scott Reeve, Dayton, OH (US); Andrew Loff, Dayton, OH (US)

Correspondence Address: REINHART BOERNER VAN DEUREN P.C., 2215 PERRYGREEN WAY, ROCKFORD, IL, 61107, US

(73) Assignee: AgVantage, Inc., Loves Park, IL (US)

(21) Appl. No.: 11/492,470

(22) Filed: Jul. 25, 2006

Related U.S. Application Data
(60) Provisional application No. 60/707,298, filed on Aug. 10, 2005.

(51) Int. Cl. B32B 7/02

(52) U.S. Cl. 428/218

(57) ABSTRACT

A composite material has two common constituents including a reinforcement (e.g. such as fiberglass, carbon fiber and/or other suitable fiber or reinforcement) and a binder material integral with the reinforcement for providing a matrix; Additionally, at least one filler is integrated with the binder, which comprises a particulate material that is formed from at least one agricultural grain or other byproduct of energy production from agricultural material. The agricultural grain particulate filler may be a refined product (e.g. starch or flour), a byproduct from grain processing such as distillers grain (DDG), and or simple ground up grain products. The invention also contemplates use of bio-energy production byproducts (to include non-grain components such as processed foliage) for other constituent parts of the composite such as reinforcement.

This patent application claims the benefit of U.S. Provisional Patent Application No. 60/707,298, filed Aug. 10, 2005.

### FIELD OF THE INVENTION

The present invention relates generally to composite materials and more specifically relates to bio-composite structures in which agricultural material is utilized in the composite material.

### BACKGROUND OF THE INVENTION

The use of composite materials in all products, from sporting goods, to aviation products, to structural support materials is increasing. Composite materials comprise two or more materials combined in such a way that the individual materials are distinguishable. Monolithic material on the other hand means the material typically consists of a single material such as glass or plastic, or in some cases a combination of materials that are indistinguishable such as a metal alloy.

In terms of providing substitutes for wood, steel and other types of metal, composite materials have been provided which include carbon and/or glass fiber reinforced structures. Composite materials offer the opportunity for comparable or better strength and stiffness characteristics typically at a mere fraction of the weight. Composite materials also offer opportunities for providing far superior corrosion resistance and insulating and thermal barrier properties.

The individual materials that make up a composite material are typically called constituents. All composites basically comprise at least two constituent materials including a binder (what is commonly referred to in the industry as forming the “matrix”); and a reinforcement. The reinforcement is usually stronger and provides for stiffness as compared with the matrix. The reinforcement defines in large part the composite material properties. The matrix holds the reinforcement in an orderly pattern, which may be flat, curved or profiled. The matrix helps to transfer loads among the different fibers and plies of the reinforcement materials. Typically and by design the matrix which transfer loads very short distances while the reinforcement bears loads over longer distances.

Reinforcement materials usually comprise one or more types of fiber material to include discontinuous fiber and continuous fiber. Continuous fibers are often preferred since there are fewer breaks in the reinforcements. As such, the matrix need only transfer loads at very short intervals. The most common materials for the reinforcements as applied to typical composite materials include: fiber glass and carbon fiber. Additionally, various bio-fibers are proposed in U.S. Patent Publication No. US 2005/0013982 to Burgueno et al. Fibers may be woven into a cloth or mat and thus bi-directional (providing support among more axes) or arranged in a “unidirectional” manner in a single ply either randomly or in a predetermined arrangement. Reinforcements may also include plastic materials, metal materials and glass fiber reinforced plastic.

The composite strength is best in the direction of the fibers. Transverse to the fiber arrangement, the matrix carries the loads. Because most applications have loads which act in several directions and/or dynamic loads, it is often preferable to orient the fibers in multiple directions. This can be accomplished by stacking multiple plies together; the stack of such plies being called a laminate. Another method along these lines is to take two reinforcement composite skins and to form a low density core between the skins, securing the skins and forming the matrix with a suitable resin. This provides a structure that carries loads similar to an I-Beam in which one of the skins is in tension while the other is in tension when placed under a perpendicular or transverse load against one of the skins.

Matrix materials are usually some type of petroleum based plastic resins. Resins are liquid polymers that can fill in the spaces around the reinforcements that when catalyzed will cure to a solid. Common plastic resin type matrices include for example polyurethane, polyvinyl chloride, epoxy, polyester, polyether, vinyl ester and other suitable types of resins. While synthetic petroleum based resins are typical, there is also known bio-based resins such as isocyanate (e.g. PMDI) and polyol soybean oil such is believed to be known in the art.

While reinforcements and matrix materials are the primary constituents of a composite material, there are also other materials which may be added which are used to modify the properties of the polymeric resins which make up the matrix. Categories of additives include reagents, fillers, viscosity modifiers, pigments and others. Fillers for example are materials which may be added to the resin to vary the properties and/or extend the volume of the matrix. Other additives such as accelerators are used to control the rate at which curing can occur. Gel coats are also used typically on the outside surface of a composite. The gel coat may include a different polyester resin that may be colored or clear to provide a cosmetic and weatherability enhancement.

While composite materials have found wide use in many higher end industries such as aircraft, wind-turbine, sporting goods and medical, the applications of composites across industry have been somewhat limited. This may be due in part to cost issues relating to existing methods of composite production as well as the cost of the input materials. Composite materials often rely heavily on petroleum based resin products, which not only is disadvantageous from a cost standpoint, but also an environmental standpoint. Petroleum reserves are also not an unlimited resource and attempts to reduce oil imports and/or oil use is desirable. Attempting to provide excellent strength and low weight properties in a composite to those of typical monolithic materials can be a challenging task while making the material in a practical and economic cost effective manner. Not surprisingly, there have been several attempts at providing solutions to these issues and some progress has been made. However, there continues to be a desire for further improvements in the composites industry for which the present invention is directed.

### BRIEF SUMMARY OF THE INVENTION

The present invention is directed toward composite material and method of making the same two of the common constituents including at least one reinforcement (e.g. such as fiberglass, carbon fiber and/or other suitable fiber or reinforcement) and at least one binder material integral with the reinforcement for providing a matrix. Additionally, at least one filler is integrated with the binder (matrix resin) or the fiber reinforcement form. In accordance with the invention the filler comprises a particulate material that is formed from at least one agricultural grain.

Certain advantages of the present invention may include a cost reduction in the manufacture of composite materials, enhanced foam expansion and other properties for certain embodiments, a reduction in the amount of petroleum-based products and/or resins which need to be provided, new markets for grain products considering the large size of grain surpluses and carryovers, and utilization of otherwise byproduct of energy production from agricultural material.

The present invention is also directed towards a method of manufacturing a composite part with the filler material. The method comprises placing suitable reinforcement such as a carbon fiber, a fiber glass cloth and/or other suitable reinforcement material on a layout table which acts as a mold for the desired shape of the product. Resin is injected into the reinforcement, and filler which comprises a particulate matter formed from a grain product is integrated with the resin material. This may be done in one of two ways to include premixing the filler with the resin and then injecting into the reinforcement; and/or first spreading and placing the filler in with the fiber reinforcement and then injecting the binder resin. After the binder resin and agricultural grain particulate filler is injected into the reinforcement, the resin is allowed to cure in which the agricultural grain particulate filler becomes integral with a matrix formed thereby which cures the reinforcement in place and forms a composite material of the desired shape.

It is also contemplated that agricultural material byproducts of energy production can be used in different ways in the composite material. For example, in addition or alternative to being a filler, the agricultural material byproducts of energy production can be used as reinforcement.

Other aspects, objectives and advantages of the invention will become more apparent from the following detailed description when taken in conjunction with the accompanying drawings.

### BRIEF DESCRIPTION OF THE DRAWINGS

FIG. 1 is a perspective view of a composite material member with a cross section being taken through one end, in accordance with one embodiment of the present invention.

FIG. 2 is a cross-section of a composite material product having multiple plies laid up and stacked upon one another, incorporating agricultural grain particulate filler in accordance with a second embodiment of the present invention.

FIG. 3 is a schematic representation of a method of manufacturing composite product using the agricultural grain particulate matter in accordance with an embodiment of the present invention.

FIGS. 4-6 are partially schematic illustrations illustrating a method of manufacturing a composite material product incorporating agricultural grain particulate filler product in accordance with another embodiment of the present invention with FIGS. 4-6 showing different steps in sequence.

FIG. 7 is a perspective view of a roadway sign made of one of the composite materials of FIGS. 1 or 2 with a transmitter embedded in the composite material.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

The following embodiments and/or examples further illustrate the invention but, of course, should not be construed as in any way limiting its scope.

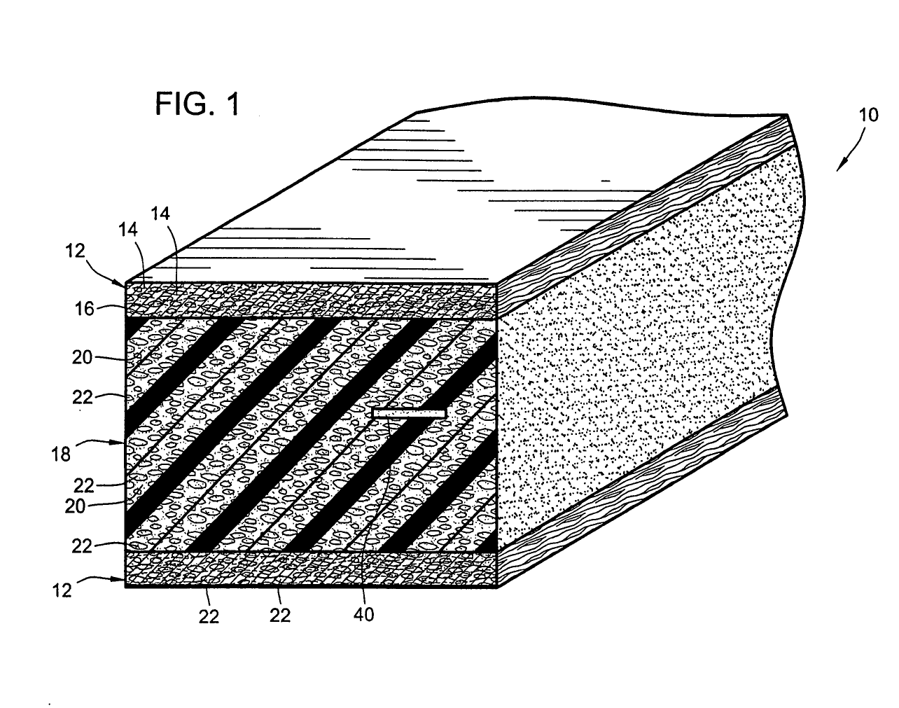

Referring to FIG. 1, a first embodiment or example of the present invention will be described. FIG. 1 generally shows a composite material product 10 of a sandwich-type design. The composite product 10 includes two outer skins 12 of reinforcement material. Suitable reinforcement materials may typically include one or more layers of fiber material 14, which may comprise fiberglass, carbon fiber, and/or other suitable forms of fiber to include natural fibers or other such reinforcement materials including reinforcements that may be made Dried Distiller's Grains (DDG) and other byproduct of energy production from agricultural material. The fiber material 14 may be discontinuous and/or continuous, may contain one or several plies, and may be unidirectional, bi or multidirectional. Fiber material 14 is typically cast and set in place with a suitable resin material 16 (as used herein, resin, binder and matrix may be used interchangeably). While fiber material is preferred, suitable monolithic materials may also be used for the skins.

The skins 12 are arranged in spaced relation and typically parallel if a flat composite material structure is desired. However the skins 12 may be molded into curved and/or round shapes or other non-planar shapes. Regardless of the arrangement, the skins 12 define an open cavity therebetween which is filled with a sandwich core material 18. The core material 18 comprises a binder such as a suitable foaming resin 20 (which may be the same but is typically different from the matrix resin 16 that binds the fiber material 14). The core material 18 can be secured to the skins 12 by the matrix resin 16 which serves to set and bind the fiber material 14 (thus forming the skins).

Suitable resins for use in embodiments include polyurethane, polyvinyl chloride, epoxy, polyester, polyether, vinyl ester and other suitable types of resins. While synthetic petroleum based resins can be used and are within the scope of the present invention, a preferred resin for environmental and petroleum conservation standpoint comprises bio-based resins such as isocyanate (e.g. PMDI) and polyol soybean oil. As a bio-based alternative to soybean oil, the following bio-based oils may be utilized in the resin material: canola (a.k.a. rape seed), sunflower, oil palm, coconut, cotton, corn, safflower, peanut, olive, and/or any other similar bio-based oil. The resin(s) integrally bonds to the entire inside surfaces of the respective skins 12 fixing them in place and additionally providing a means for transferring and carrying loads between the two skins 12. As a result, one skin may be in tension while the other skin is in compression providing vastly improved structural strength.

The core material 18 is typically of substantially lower density than the skins 12 to provide for an overall low weight, low density composite material 10. The core material is often in the form of relatively stiff foam to include air/gas pockets formed throughout. Suitable accelerators and other additives can control the expansion and cure of the resin 20 to provide the desired density and/or foam properties. As indicated above, the core material 18 is usually preformed into the desired shape and size prior to attachment of the skins (typically the shape of a rectangular block for planar composites).

In accordance with an aspect of the present invention, the matrix resin material 16 may comprise a particulate filler 22. The agricultural grain particulate filler 22 is spread substantially evenly throughout the resin 16 of the core and conglomerated therein to provide structural support and decrease the amount of resin necessary for filling in and binding the fiber material 14 to form the skins 12. The agricultural grain particulate filler 22 thus becomes integrated with the resin 16. The matrix resin 16 permeates the fiber material 14 and fuses with the core material 18 to bind the skins 12 to the core material 18.

Similarly and optionally, and in accordance with a further aspect of the present invention, the core material 18 may also comprise a particulate filler 22 formed from an agricultural grain. The agricultural particulate filler 22 is spread substantially evenly throughout the resin 20 of the core material 18 and conglomerated therein to provide structural support and decrease the amount of resin necessary for filling in and providing the core material 18. The agricultural particulate filler 22 thus becomes integrated with the resin 20.

For most applications, the agricultural grain particulate filler 22 may be integrated at a rate of about 0.5 lbs to about 3 lbs per square foot. Considered a different way, the agricultural grain particular filler 22 can form between 1 and 50% by weight of the resin measured before curing the resin.

The agricultural grain particulate filler 22 may be formed from any suitable agricultural grain to include, for example: corn, soybean, wheat, barley, oats, sorghum (milo), sunflower, safflower, buckwheat, flax, peanut, rice, rape/canola, rye, millet, triticale, chickpeas, lentils, and field peas and/or harvestable flower portion of a plant. The agricultural grain particulate filler may be a refined product (e.g. starch or flour), a waste byproduct from grain processing, and or simple ground up grain products. One preferred filler material is Dried Distiller's Grain (DDG), which is a common byproduct of ethanol production or other alcohol production. Considering DDGs typically have little value elsewhere and are often considered to be a waste product from ethanol production. Considering that about one in six rows of corn in the United States are dedicated to ethanol production, the present invention provides an advantageous and beneficial use for such byproduct of ethanol production. It would be appreciated that other particulate matter made from at least one agricultural grain may be used to include flour, hulls, chaff, whole or crushed grain, and the like. Similarly, corn oil extracted from ethanol production may be used in the resins.

The grit size of the agricultural particulate filler may range from smaller grit sizes (e.g. 1-4 millimeters average size) up to about 8-16 millimeters average size (measured by minimum cross sectional dimension utilizing a screen pass test). The agricultural grain particulate filler preferably has relatively low moisture content.

According to an example, a single type of agricultural particulate filler 22 is used such as distiller's grain which can be added as filler an integrated with any of the resins mentioned above in laying up the composite material. According to an embodiment, about one pound of distiller's grain (DDG or other product) is added at the rate of about 1 pound per square foot (as measured by the external surface area of the composite material).

Advantages and different properties may be had by utilizing more than one type of agricultural grain particulate filler 22 with a resin. As another example, a combination of wheat flour or other grain flour (added at the rate of about 1 pound per square foot) and distillers grain (DDG's also added at the rate of about 1 pound per square foot) is integrated with the resin. Using different types allows for more biomass grain product to be utilized in the composite product. The size distinctions and integrating different properties agricultural filler 22 also can provide for different properties and characteristics.

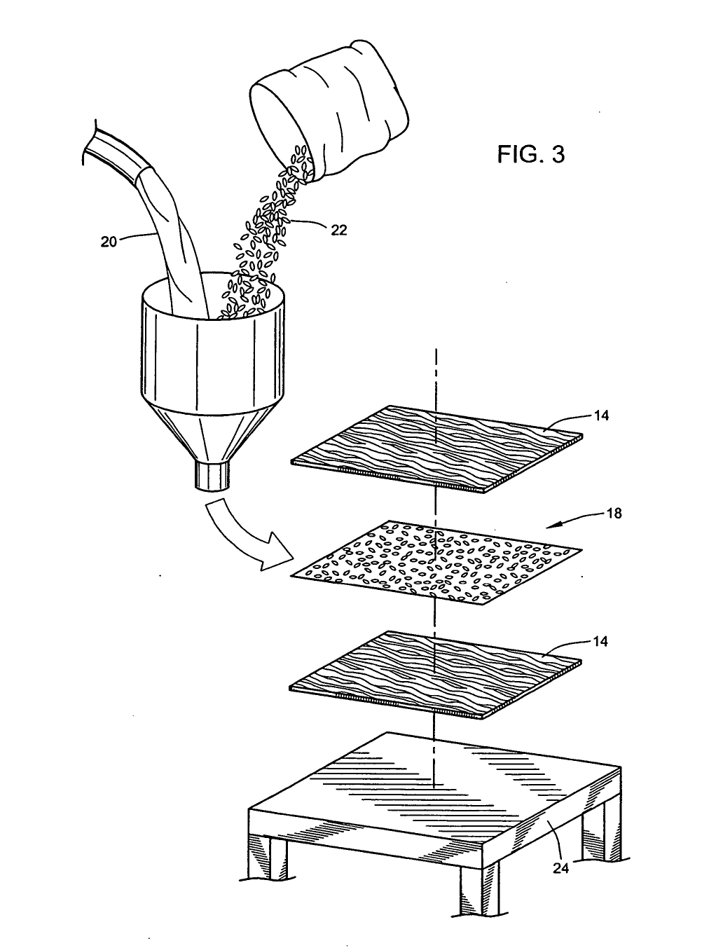

FIG. 3 illustrates schematically an embodiment for manufacturing the sandwich type composite material 10 illustrated in FIG. 1. The method comprises placing suitable reinforcement material such as carbon or glass fiber material 14 which may be in the form of a cloth and/or other suitable fiber material on a layout table 24. The layout table 24 acts as a mold for the desired shape of the composite material product. In this embodiment the agricultural grain particulate filler 22 is premixed with the resin 16 and then injected into the open voids 26 defined within the fiber material 14 to form the skins 16. The resin 16 sets the fiber material and also secures the skins 12 to the core material 18. The core material 18 is typically preformed and either cut or molded into the desired shape and thus is relatively hard and receptive to the resin 16. After the mixed binder resin 16 and agricultural grain particulate filler 22 is injected into the reinforcement skins 12 (with or without suitable additives such as accelerators), the resin 16 is allowed to cure in which the agricultural grain particulate filler becomes integral with a matrix formed thereby which cures the and sets the reinforcement skins 12 to the desire shape of the composite material 10. In this sandwich type composite material embodiment, the core material 18 is of relatively rigid low density core foam while the skins are of a much higher density to provide for a low weight composite product that exhibits excellent strength characteristics.

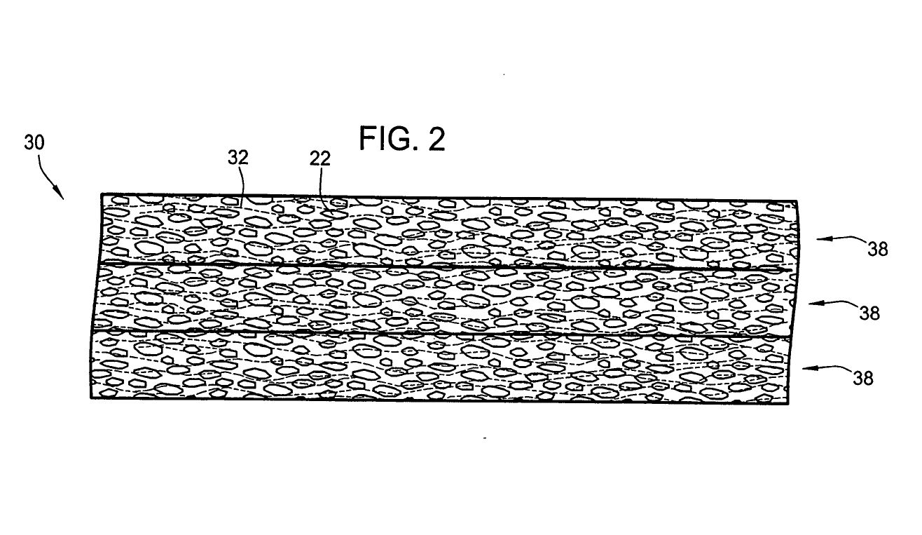

A second embodiment of the present invention is illustrated in FIG. 2 shown as a composite material 30 that includes one or more stacked plies 38 of reinforcement fibers 32 which are laid up one on top of another to form a laminate structure with a relatively consistent density throughout rather than a low density core. The reinforcement fibers 32 may be any of those previously described or other such reinforcement suitable for composite materials. Additionally a suitable binder such as resin 34 is injected into and substantially encapsulates the reinforcement fibers 32 to form a matrix which sets the fibers 32 in place. The resin matrix may be any of those previously described or other such resin matrix which is suitable for composite materials. Additionally, the agricultural grain particulate filler 22 is integrated into the resin 34 matrix. The agricultural particulate filler 22 may be any of those types disclosed herein and can be added at the same rates and manners as for the first embodiment.

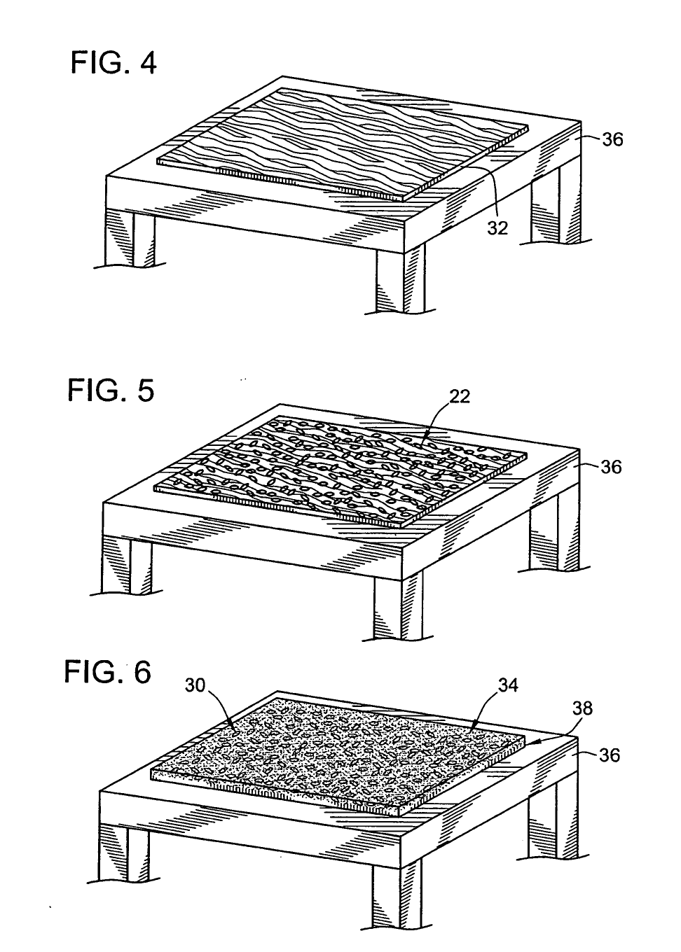

FIGS. 4-6 schematically illustrate an example of a method for laying up a ply of the second embodiment. The method comprises placing suitable reinforcement fibers 32 such as a carbon fiber, a fiber glass cloth and/or other suitable reinforcement material including reinforcement made from DDG and other byproduct of energy production from agricultural material on a layout table 36 which acts as a mold for the desired shape of the product. This is shown in FIG. 4. Then as shown in FIG. 5, a particulate matter 16 formed from a grain product is spread out and integrated with the reinforcement fibers 32 first. Thereafter binder resin 34 is injected into the reinforcement fiber 32 and particulate fiber 14 to complete the ply 38. The steps of 4-6 can be repeated to layer reinforcement fibers 32 and generate multiple plies 38 as shown in FIG. 2 to form a laminate structure with the agricultural grain particulate filler 22 integrated throughout. Although it is desirable to have the agricultural particulate filler 22 throughout, it will be appreciated that not all plies require the filler, and the filler 22 may be restricted to certain plies. After the binder resin and the agricultural particulate filler is injected into the reinforcement, the resin is allowed to cure in which the agricultural particulate filler becomes integral with a matrix formed thereby which cures the reinforcement in place and forms a composite material of the desired shape.

A further aspect which relates to composite materials generally but can be independent of the agricultural particulate filler aspect is the concept of embedding a radio frequency identification chip (RFID chip) 40 in the resin composite material 10 or 30 as shown in the embodiments of FIGS. 1 and 2. This provides a mechanism for tracking the location of an item. For the sandwich composite structure illustrated in FIG. 1, preferably the RFID Chip 40 is integrated into the core material 18 and therefore hidden and not just embedded but also completely encapsulated within the composite material 10. Encapsulation protects the RFID chip 40 and considering that the composite material is non metallic/magnetic and protected from the environment, the RFID chip 40 has excellent operational reliability. The second embodiment of FIG. 2 also shows the RFID chip 40 to be encapsulated, but it will also be appreciated that in any composite structure the RFID chip may also simply be imbedded in an external surface and therefore accessible. Alternatively or additionally, a Radio Frequency transmitter 42 can also be embedded within the composite material.

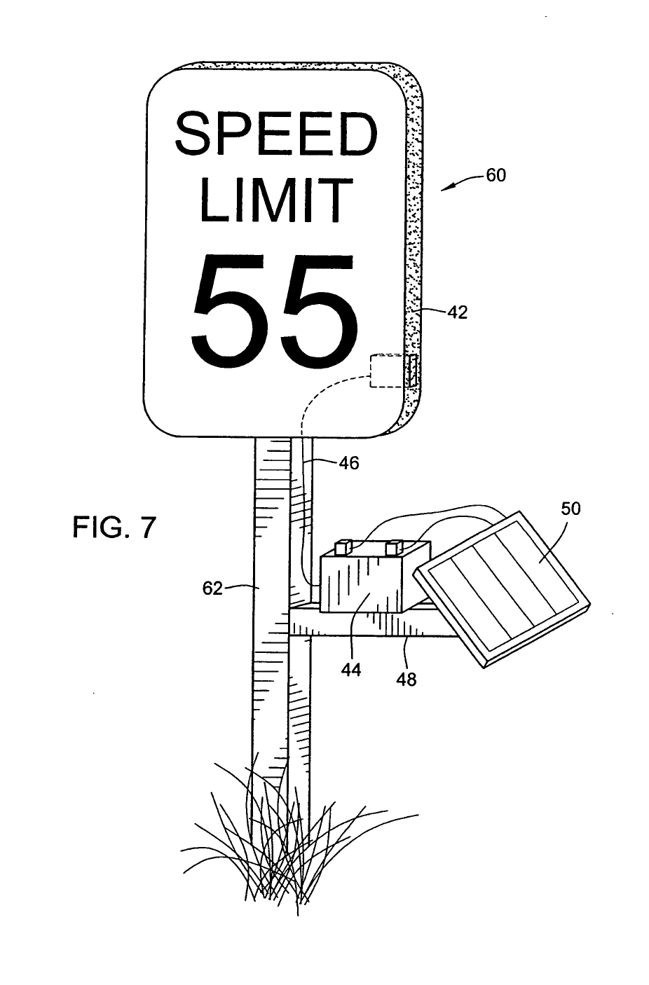

An example of one use for the RFID chip and/or transmitter is in a roadway sign 60 as illustrated in FIG. 7. The roadway sign 60 is manufactured from the composite material such as the sandwich composite of FIG. 1 or multiple ply laminate of FIG. 2. The sign 60 is mounted on a post 62. As shown in FIG. 7, the transmitter 42 is embedded in the composite material sign 60. To power the transmitter 42 a wire connects the transmitter to a suitable power source, such as a solar panel 50 and/or a battery 44 (which may be recharged by the solar panel 50). These components are mounted via a bracket 48 to the post 62.

In addition to energy production byproducts formed from agricultural grain, it has been recognized that ethanol or other bio-based energy production can incorporate other parts of the plant, to include the foliage (leaves, stems etc). As a result, the present invention also is intended to cover other byproducts of bio-based energy production from agricultural material. The agricultural filler 22 may also be formed from any such agricultural material byproducts of energy production to include the foliage from corn, soybean, flaxseed, switchgrass, rapeseed, miscanthus, stover, hay, straw, bagasse from sugarcane, jatropha, or other such foliage crop which is used in bio-based energy production. Such foliage can be processed with the grain in energy production. Thus, as used herein, byproducts of bio-based energy production from agricultural material and other similar terms is meant to include energy production from grains and/or foliage.

In utilizing all references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A composite material, comprising:
at least one reinforcement;
at least one binder material integral with the reinforcement; and
at least one filler integrated in the binder, the filler comprising a particulate material formed from at least one agricultural grain.

2. The composite material of claim 1, wherein the agricultural grain comprises at least one of the group consisting of corn, soybean, wheat, barley, oats, sorghum (milo), sunflower, safflower, buckwheat, flax, peanut, rice, canola, rye, millet, triticale, chickpeas, lentils, and field peas.

3. The composite material of claim 1, wherein the particulate matter comprises a refined flour made from the at least one agricultural grain.

4. The composite material of claim 1, wherein the particulate matter comprises a waste byproduct of grain processing.

5. The composite material of claim 1, wherein the particulate matter comprises distiller grain.

6. The composite material of claim 1, wherein the reinforcement comprises at least one ply of a fiber material comprising at least one of a carbon fiber material, a glass fiber material and a bio based fiber.

7. The composite material of claim 1, wherein the reinforcement comprises multiple stack plies.

8. The composite material of claim 1, wherein a sandwich structure is provided wherein the reinforcement is provided in at least high density plies in spaced relation and a core of a lower density interposed therebetween, the core comprising at least one of the binders and the filler material.

9. The composite material of claim 1, wherein said at least one binder comprises at least one of resins selected from the group consisting of polyurethane, polyvinyl chloride, epoxy, polyester, polyether, and vinyl ester.

10. The composite material of claim 1, wherein said at least binder comprises at least one bio-based polymer.

11. A composite material, comprising:
at least one reinforcement;
at least one binder material integral with the reinforcement; and
wherein the composite material includes at least one byproduct of energy production generated from at least one agricultural material.

12. The composite material of claim 11, wherein the agricultural material for the energy production comprises at least one of the group consisting of corn, soybean, flaxseed, switchgrass, rapeseed, miscanthus, hulls, stover, straw, bagasse from sugarcane and jatropha.

13. The composite material of claim 11, wherein the byproduct of energy production is made at least in part from the foliage of the agricultural material.

14. The composite material of claim 11, wherein the byproduct of energy production is made at least in part from the grain of the agricultural material.

15. The composite material of claim 11, wherein the reinforcement comprises at least one ply of a fiber material comprising at least one of a carbon fiber material, a glass fiber material and a bio based fiber.

16. The composite material of claim 11, wherein the reinforcement comprises at least oneply of a fiber incorporating a the at least one byproduct of energy production from agricultural material.

17. The composite material of claim 11, wherein the reinforcement comprises multiple stack plies.

18. The composite material of claim 11, wherein a sandwich structure is provided wherein the reinforcement is provided in at least high density plies in spaced relation and a core of a lower density interposed therebetween, the core comprising at least one of the binders and the filler material.

19. The composite material of claim 11, wherein said at least one binder comprises at least one of resins selected from the group consisting of polyurethane, polyvinyl chloride, epoxy, polyester, polyether, vinyl ester, and a bio-based polymer.

20. The composite material of claim 11, wherein the byproduct of energy production is used at least in part as a filler in the composite material.

21. The composite material of claim 11, wherein the byproduct of energy production is used at least in part as the reinforcement in the composite material.
